(19) United States
(12) Patent Application Publication
(10) Pub. No.: US 2013/0173644 A1
(43) Pub. Date: Jul. 4, 2013

(54) COMPUTING APPARATUS AND METHOD FOR PROVIDING CONTENTS THEREOF

(71) Applicants: Do Hyun PARK, Seongnam-si (KR); Yong Jae PARK, Yongin-si (KR)

(72) Inventors: Do Hyun PARK, Seongnam-si (KR); Yong Jae PARK, Yongin-si (KR)

(21) Appl. No.: 13/420,904

(22) Filed: Mar. 15, 2012

(30) Foreign Application Priority Data
Dec. 28, 2011 (KR) 10-2011-0144948

(51) Int. Cl. G06F 17/30

(52) U.S. Cl. 707/758; 707/E17.108; 707/E17.032

(57) ABSTRACT

Disclosed is a contents providing method of a computing apparatus. The contents providing method includes storing highlighted contents in a storage unit; searching the highlighted contents based on a search condition; reading the highlighted contents from the storage unit according to a search result; and providing the read highlighted contents to a user via a display unit.

### CROSS-REFERENCE TO RELATED APPLICATIONS

A claim for priority under 35 U.S.C. §119 is made to Korean Patent Application No. 10-2011-0144948 filed Dec. 28, 2011, in the Korean Intellectual Property Office, the entire contents of which are hereby incorporated by reference.

### BACKGROUND

Exemplary embodiments relate to a computing apparatus and a contents providing method thereof, and more particularly, relate to a computing apparatus providing an effective academic studying means and a community linking means and a contents providing method thereof.

In recent years, as the use of smart computing devices has become widespread, there has been an increase in the number of users that are provided with contents using computing devices. For example, users can use such devices to gain access to educational, entertainment, office, and various other contents.

In computing devices, however, the rate for software development to make such contents more efficient and accessible is slower than that for hardware development. Therefore, software development focusing on user accessibility and device efficiency needs to be expedited.

### SUMMARY

Example embodiments of the inventive concept provide a contents providing method of a computing apparatus, which comprises storing highlighted contents in a storage unit; searching the highlighted contents based on a search condition; reading the highlighted contents from the storage unit according to a search result; and providing the read highlighted contents to a user via a display unit.

In example embodiments, the contents providing method further comprises providing a writing area to receive a written input of the user via the display unit.

In example embodiments, the highlighted contents include one of a highlighted field, a page area containing the highlighted field, an address of the highlighted field, or an address or hyperlink of the page area.

In example embodiments, the highlighted field is highlighted through an underline or painting.

In example embodiments, the searching the highlighted contents comprises providing the search result to the user via the display unit.

Example embodiments of the inventive concept also provide a contents providing method of a computing apparatus, which comprises receiving a community access command from a user; determining a community corresponding to target contents based on the community access command; connecting to the community through a wired or wireless network via a network unit; receiving community contents from the community through the network unit; and providing the community contents to the user via a display unit.

In example embodiments, the target contents include contents being read by the user through the computing apparatus or contents configured by the user beforehand.

In example embodiments, the contents being read or the contents preconfigured include e-book contents.

In example embodiments, the community contents include at least one of a web document, a picture, a video, sound data, or a hyperlink.

In example embodiments, the community includes an internet website, a social network service (SNS), or a messenger

In example embodiments, the social network service includes Google+, facebook, blog, twitter, me2 day, or weibo.

In example embodiments, the messenger includes kakaotalk, mypeople, tictoc, or line.

In example embodiments, the contents providing method further comprises receiving user contents from the user; and providing the user contents to the community via the network unit.

In example embodiments, the user contents include a web document, a picture, a video, sound data, or a hyperlink provided to the community by the user.

In example embodiments, the contents providing method further comprises providing user information to the community.

In example embodiments, the user information includes login information required to log-in to the community.

Example embodiments of the inventive concept also provide a computing apparatus which comprises a storage unit configured to store highlighted contents; a control unit configured to search the highlighted contents based on a search condition and to read the highlighted contents from the storage unit based on the search result, and a display unit configured to provide the read highlighted contents to a user.

In example embodiments, the highlighted contents include one of a highlighted field, a page area containing the highlighted field, an address of the highlighted field, or an address or hyperlink of the page area.

In example embodiments, the display unit provides the search result to the user.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a computing apparatus according to an embodiment of the inventive concept.

FIG. 2 is a diagram describing a highlight method according to an embodiment of the inventive concept.

FIG. 3 is a diagram describing a contents searching method according to an embodiment of the inventive concept.

FIGS. 4A and 4B are diagrams schematically illustrating highlighted contents displayed in a detailed view mode.

FIG. 5 is a flowchart describing a contents providing method according to an embodiment of the inventive concept.

FIG. 6A is a diagram describing a community access method according to another embodiment of the inventive concept.

FIG. 6B is a diagram schematically illustrating community contents according to another embodiment of the inventive concept.

FIG. 7 is a flowchart describing a contents providing method according to another embodiment of the inventive concept.

FIG. 8 is a diagram describing a writing-inhibited area setting method of a computing device according to an embodiment of the inventive concept.

FIG. 9A is a diagram describing a writing-inhibited area setting method of a computing device according to another embodiment of the inventive concept.

FIG. 9B is a diagram describing a writing-inhibited area setting method of a computing device according to still another embodiment of the inventive concept.

FIG. 10 is a diagram describing a writing-inhibited area setting method of a computing device according to still another embodiment of the inventive concept.

FIG. 11 is a flowchart describing a touch recognizing method of a computing apparatus according to an embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

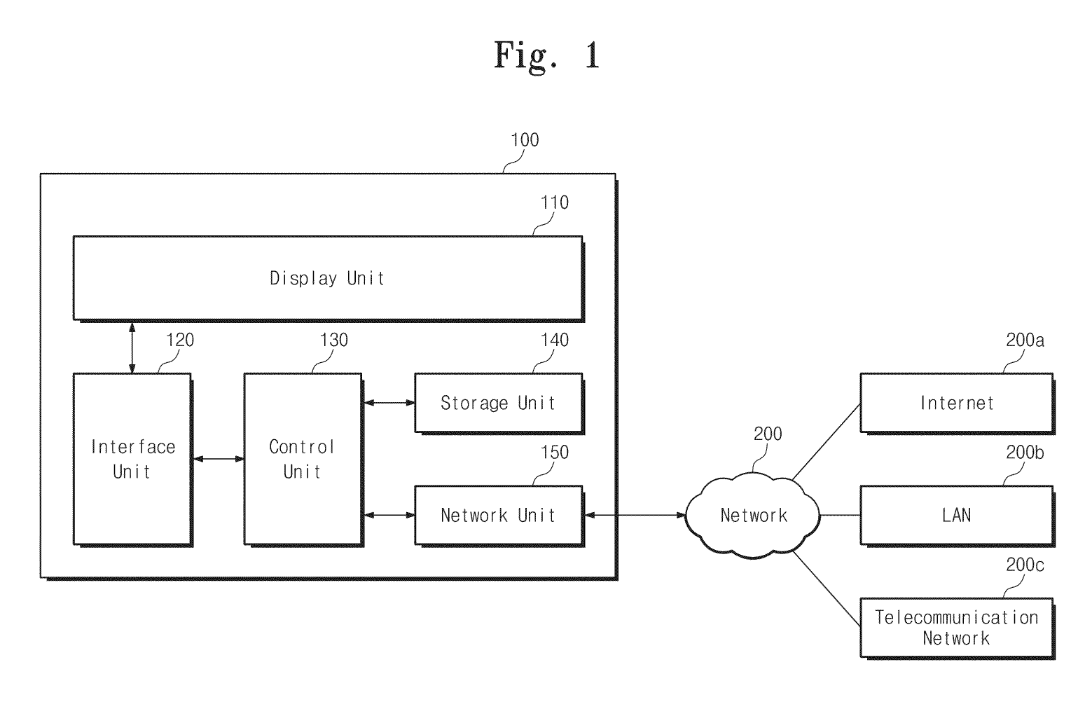

FIG. 1 is a block diagram schematically illustrating a computing apparatus according to an embodiment of the inventive concept. Referring to FIG. 1, a computing apparatus 100 includes a display unit 110, an interface unit 120, a control unit 130, a storage unit 140, and a network unit 150.

The display unit 110 is a device which receives a video signal from the interface unit 120 and displays the contents through the screen to the user. Also, the display unit 110 can provide graphic user interface (GUI) to the user. The display unit 110 displays e-book and contents or highlighted contents on the screen.

A contents display method of the display unit 110 and the highlighted contents will be more fully described later.

In example embodiments, the display unit 110 may include a touchpad (not shown). In this case, the display unit 110 senses touch signals of the user. The sensed touch signals are provided to the interface unit 120.

The user may highlight a part of the contents displayed by the display unit 110. The highlight function is used to differentiate a part of the contents from the rest thereof. Herein, the contents may include a text, a picture, or a specific region of a displayed screen.

In more detail, the user may underline or paint a portion of the contents in a particular color. In example embodiments, auto-marking can be used as an underlining method. In other example embodiments, there can be used a method in which the user directly draws a line on the display unit 110. Underlining or painting made by the user may be recognized by the display unit 110 via a touch sensing manner.

The display unit 110 provides a writing method using the touch sensing manner. The writing method provided by the display unit 110 is controlled by the control unit 130. The writing method may include a first area being writable and a second area being write-inhibited.

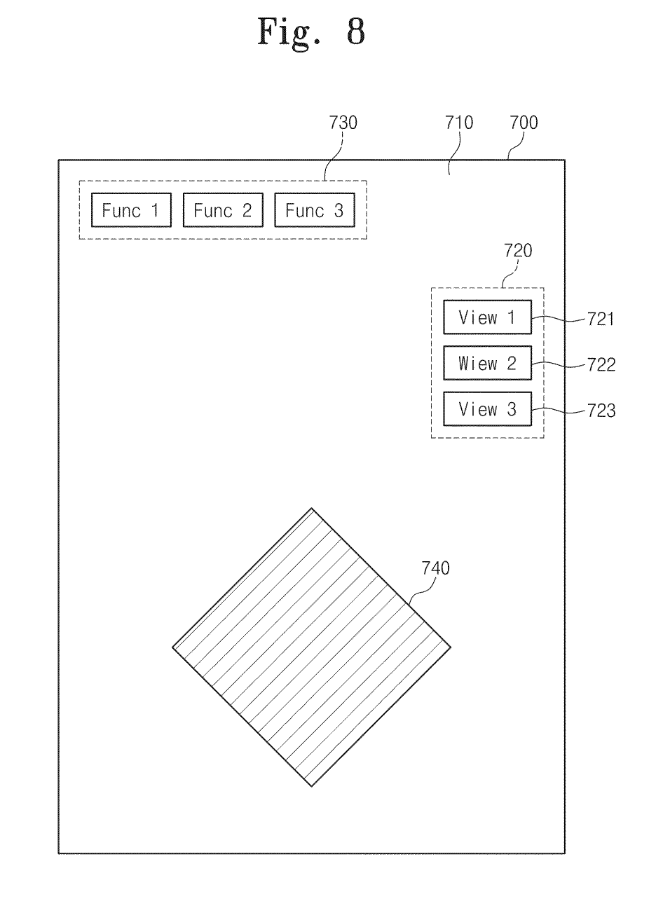

The writing method will be more fully described with reference to FIGS. 8 to 11.

The interface unit 120 is configured to interface with the control unit 130 and display unit 110. The interface unit 120 delivers a control signal or a video signal provided by the control unit 130 to the display unit 110.

The interface unit 120 may be well known in the art, and description thereof is thus omitted.

The control unit 130 controls constituent elements 110, 120, 140, and 150 of the computing apparatus 100. In the inventive concept, the control unit 130 collects/extracts highlighted contents to store it in the storage unit 140. The highlighted contents collected/extracted by the control unit (130) include a field highlighted by the user.

In example embodiments, the highlighted contents may include a page containing a field highlighted by the user. In other words, if a particular passage is highlighted by the user, the control unit 130 can collect the entire page containing the highlighted passage as the highlighted contents.

To reduce a size of stored data, the control unit 130 collects an address of the highlighted field or an address of the page containing the highlighted field as the highlighted contents. Herein, the address may indicate a location of the highlighted field or a location of a portion of a page (i.e., which page of which chapter and/or which line in a page).

In example embodiments, the highlighted contents may include the hyperlink connecting to the highlighted field or the portion of the page.

The control unit 130 provides users with a search interface for the highlighted contents. The search interface may be provided by the display unit 110. The user can input a search condition using the search interface. In example embodiments, the search condition may include a highlight color or an address of highlighted contents.

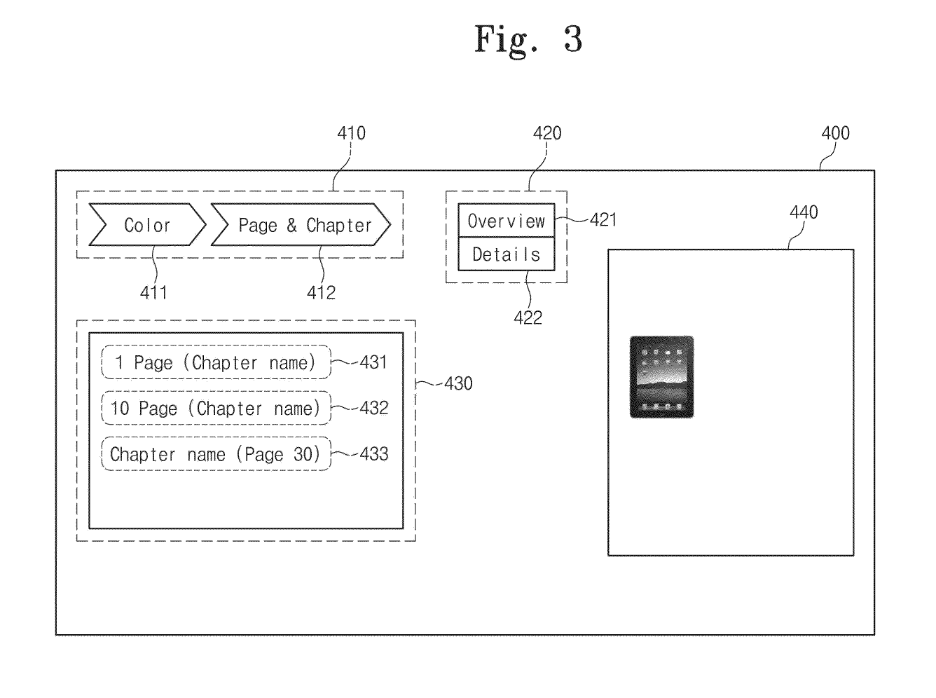

The search interface will be more fully described with reference to FIG. 3 later.

The control unit 130 searches the highlighted contents from the storage unit 140 based on the search condition input by the user. The control unit 130 provides search results to the user through the display unit 110.

The control unit 130 provides an interface allowing the user to readily connect to various communities. In example embodiments, the control unit 130 provides a method for the user to connect to communities in relation to the contents being used.

For example, in a case where a user reads the contents called “fundamentals of mathematics” through the computing apparatus 100, the control unit 130 provides an interface that allows the user to connect to an online community related to “fundamentals of mathematics”.

In more detail, when the user inputs a command for connecting with the community, the control unit 130 may perform a community connecting operation. First, the control unit 130 extracts a community address of the “fundamentals of mathematics” contents. Herein, the community address of the contents may be provided by the provider associated with the “fundamentals of mathematics” contents. Alternatively, the community address may be entered beforehand by the user.

Then, the control unit 130 refers to the community address to connect the computing apparatus 100 to a relevant community site through the network unit 150. In example embodiments, the control unit 130 may automatically provide user information to the community site to be connected to the community site. The user information may include login information required to log in to the community site.

The contents provided from the community site are provided to the user. Herein, the contents from the community site may be provided through the web browser or Windows. In example embodiments, the contents provided from the community site may include web documents, video data, picture data, sound data, and/or hyperlinks.

According to the above-described embodiments, the user may easily and quickly access the community site related to the contents that are in use. The user may gather information, ask questions, and provide the community site with information that the user is aware of. Alternatively, the user may upload or download files such as video data or sound data associated with the community site. The user may also communicate with other users in real time using the group instant messaging service or webcam service provided by the community site.

The storage unit 140 stores the highlighted contents provided by the control unit 130. The storage unit 140 may include a nonvolatile memory. In example embodiments, the storage unit 140 may include hard disk disks, flash memories, or solid state drives.

The network unit 150 interacts with an external network 200. The network unit 150 sends signals provided by the control unit 130 to the external network 200. The network unit 150 sends the signals provided by the external network 200 to the control unit 130.

The network unit 150 may be well known in the art, and description thereof is thus omitted.

The external network 200 may include a wired or wireless communications network. In example embodiments, the external network 200 may include an internet network 200a, a local area network 200b, or a telecommunication network 200c.

According to the above description, the computing apparatus 100 collects and stores the contents highlighted by the user. Based on the search condition input by the user, the computing apparatus 100 effectively searches highlighted contents corresponding to the search condition to provide it to the user. The user may readily access an external community corresponding to the contents that the user views through the computing apparatus 100. The computing apparatus 100 provides the user with the writing method using a touch sensing manner. As a result, the educational effect and performance of the user utilizing the contents may be enhanced.

In example embodiments, the computing apparatus 100 according to an embodiment of the inventive concept may support a cloud service to back up contents or data stored in the computing apparatus 100. In detail, the computing apparatus 100 accesses the cloud service provider via the network unit 150. The computing apparatus 100 frequently transmits the stored data or contents in the computing apparatus 100 to a cloud server (not shown) provided by the cloud service provider.

With the above-described method, the stored data or contents in the computing apparatus 100 can be backed up in the cloud server. Therefore, the user may restore the data or contents of the computing apparatus 100 from the cloud server even if they are lost.

Also, the user downloads data or contents stored in the cloud server using other terminals (e.g. a personal computer, a smartphone, etc.). Therefore, the user may access the stored data and contents of the computing apparatus 100 using other terminals without the computing apparatus 100.

A manner in which the computing apparatus 100 interfaces with the cloud server through the cloud service may be well known in the art, and description thereof is thus omitted.

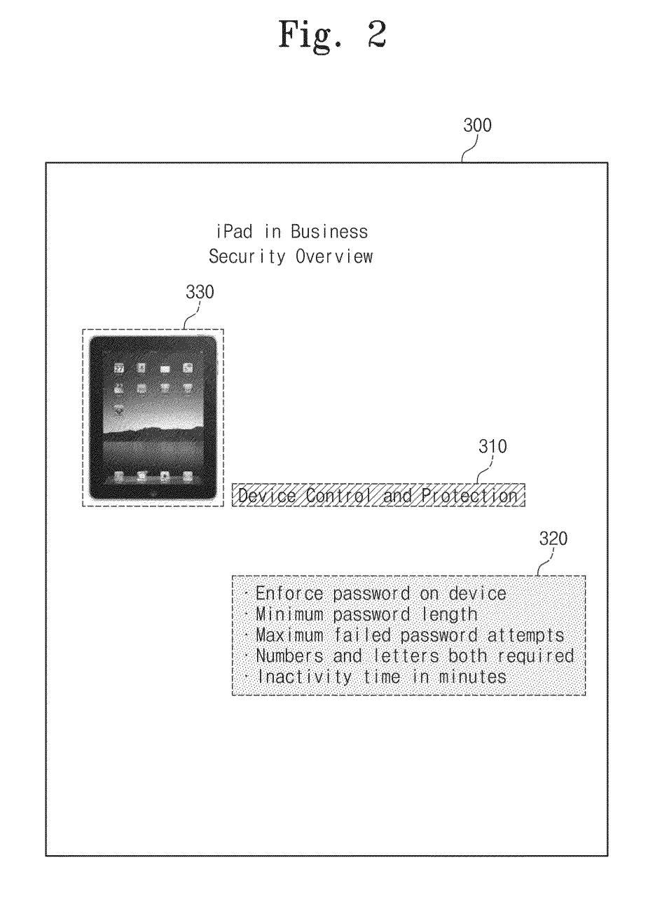

FIG. 2 is a diagram describing a highlight method according to an embodiment of the inventive concept. Referring to FIG. 2, a screen 300 of a display unit 110 (refer to FIG. 1) includes the contents or a plurality of highlighted fields 310 and 320.

The user may select and highlight a portion of the contents displayed on the screen 300. The screen 300 represents the two fields 310 and 320 highlighted by the user. In FIG. 2, there is illustrated an example that the screen 300 includes two fields 310 and 320 highlighted by the user. In example embodiments, the fields 310 and 320 may be highlighted by painting the fields 310 and 320. However, the inventive concept is not limited thereto. For example, the fields 310 and 320 may be highlighted using underlines.

In example embodiments, the user highlights the selected fields 310 and 320 with an identical color or different colors. The highlighted fields 310 and 320 may be classified as the same group or different groups based on the color chosen for highlighting. For example, the fields 310 and 320 highlighted in yellow may be separately collected, extracted, and stored. The fields 310 and 320 highlighted in yellow may be searched and provided to the user depending on a search condition.

In example embodiments, the user highlighted a passage included in the displayed contents. However, the inventive concept is not limited thereto. For example, the user may also highlight a paragraph, a picture 330, and/or a specific area of the contents.

A control unit 130 (refer to FIG. 1) collects the highlighted fields 310 and 320 to store them into a storage unit 140 as highlighted contents. In example embodiments, the highlighted contents include a paragraph or page area including the highlighted fields. For example, the highlighted contents may include highlighted field 310, paragraphs containing the highlighted field 310, or the entire page containing the highlighted field 310.

In example embodiments, the highlighted contents may include an address or a hyperlink associated with the highlighted field or page area. Detailed explanation on the address or the hyperlink of the highlighted field or the page area may be substantially identical to that mentioned above.

FIG. 3 is a diagram describing a contents searching method according to an embodiment of the inventive concept. Referring to FIG. 3, a computing apparatus 100 (refer to FIG. 1) provides a contents search interface to the user. As illustrated in FIG. 3, a screen 400 of a display unit 110 (refer to FIG. 1) includes a search condition field 410, a display mode selection field 420, a search result field 430, and an overview display area 440.

Below, there will be described a method in which the user searches highlighted contents through the content search interface.

First, the user inputs a search condition through the search condition field 410. The search condition field 410 includes a color tab 411 and a location tab 412. The color tab 411 is used to enter a highlighted color or highlighted contents. The location tab 412 is used to enter a location of the highlighted contents.

For example, if the user enters yellow in the color tab 411, the control unit 130 (refer to FIG. 1) searches the contents highlighted in yellow from a storage unit 140 (refer to FIG. 1). The highlighted contents may be equal to that described above.

When the user enters chapter 1 or page 412 in the location tab 412, the control unit 130 searches the highlighted contents located in chapter 1 or page 412 from the storage unit 140. In example embodiments, the color condition and the location condition may be used independently or in combination.

The user selects a display mode for the searched highlighted contents through the display mode selection field 420. In example embodiments, the display mode selection field 420 may include an overview tab 421 and a detailed view tab 422.

If the user selects one of the overview tab 421 and the detailed view tab 422, the display unit 110 displays the searched contents in an overview mode or a detailed view mode.

In the overview mode, the highlighted contents are briefly displayed on a small screen. In example embodiments, at overview mode, the highlighted contents are displayed on in the overview display area 440.

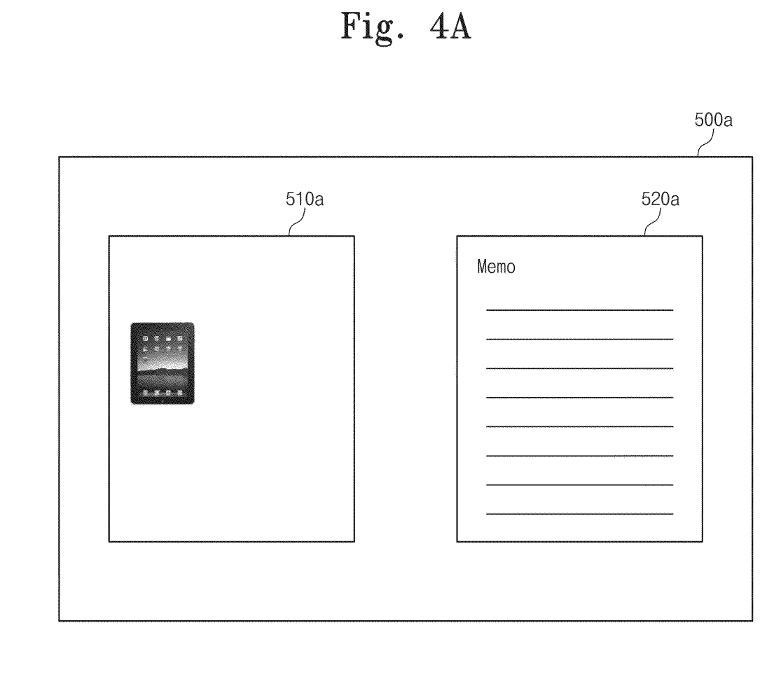

In the detailed view mode, the highlighted contents are displayed on a large screen in detail. In example embodiments, at the detailed view mode, the highlighted contents are provided along with the memo field. The detailed view mode will be more fully described with reference to FIG. 4A.

The control unit 130 searches the highlighted contents from the storage unit 140 based on the search condition. The search result of the storage unit 130 is displayed in the search result field 430. In example embodiments, the search result field 430 includes a list of searched highlighted contents 431, 432, and 433. The list of highlighted contents is displayed by the location or the address of the highlighted contents. In this case, the list of highlighted contents 431, 432, and 433 can be displayed by the page or chapter in which they are located.

In example embodiments, the user may decide highlighted contents to be displayed in the display unit 110 by selecting one of the highlighted contents 431, 432, and 433.

According to the above description, highlighted contents may be searched and provided to the user based on the search condition.

FIGS. 4A and 4B are diagrams schematically illustrating highlighted contents displayed in a detailed view mode. In FIGS. 4A and 4B, there is illustrated an example that highlighted contents are provided along with a memo field.

Referring to FIG. 4A, a screen 500a in a display unit 110 (refer to FIG. 1) contains a highlighted contents display field 510a and a memo field 520a. The highlighted contents display field 510a and the memo field 520a are located in parallel with respect to a horizontal direction.

The highlighted contents display field 510a displays highlighted contents. The memo field 520a provides a memo area for the user. The user takes notes or memos in the memo field 520a while reading the highlighted contents displayed in the highlighted contents display field 510a.

In example embodiments, a computing apparatus 100 may recognize notes or memos written by the user by a touch sensing manner.

Referring to FIG. 4B, a screen 500b in a display unit 110 (refer to FIG. 1) includes a highlighted contents display field 510b and a memo field 520b. As illustrated in FIG. 4B, the highlighted contents display field 510b and the memo field 520b are located vertically to each other.

The highlighted contents display field 510b and the memo field 520b may be substantially identical to those described in FIG. 4A.

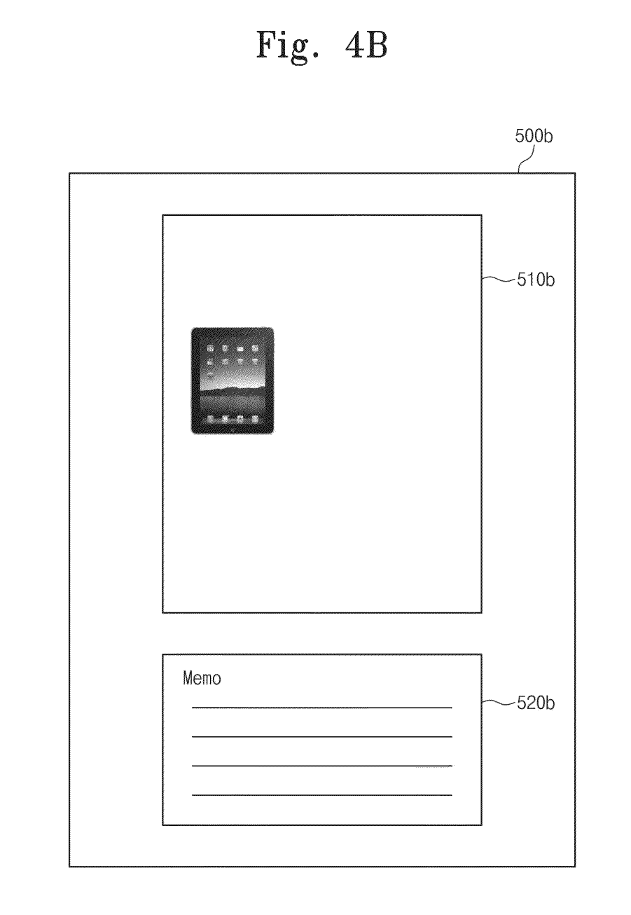

FIG. 5 is a flowchart describing a contents providing method according to an embodiment of the inventive concept. A contents providing method providing collected and extracted highlighted contents to the user will be described with reference to FIG. 5. Referring to FIG. 5, a contents providing method according to an embodiment of the inventive concept may include operations S110 to S150.

In operation S110, a control unit 130 (refer to FIG. 1) collects highlighted contents to store them in a storage unit 140 (refer to FIG. 1). The highlighted contents may be collected in the same manner as described above.

The storage unit 140 may include a nonvolatile memory. In example embodiments, the storage unit 140 may include a hard disk drive, a flash memory, and/or a solid state drive.

In operation S120, a computing apparatus 100 (refer to FIG. 1) provides a search interface for searching the highlighted contents through a display unit 110 (refer to FIG. 1). The control unit 130 receives a search condition from the user through the search interface. The control unit 130 searches the highlighted contents in the storage unit 140 based on the input search condition.

Searching of highlighted contents via the search interface and the control unit 130 may be performed in the same manner as described above.

In operation S130, the control unit 130 judges whether the highlighted contents searched according to the searched condition exist. If so, the method proceeds to operation S140. If not, the method proceeds to operation S150.

In operation S140, a display unit 110 outputs the searched highlighted contents. In example embodiments, the display unit 110 may provide a list of searched highlighted contents through the search interface.

Then, the user refers to the list of the highlighted contents to select wanted highlighted contents. In example embodiments, the user can select a plurality of highlighted contents based on the list of the highlighted contents.

The display unit 110 provides the selected highlighted contents through a screen. In example embodiments, the display unit 110 may provide the user with the selected highlighted contents in an overview mode or a detailed view mode.

The highlighted contents may be provided to the user via the display unit 110 in the same manner as described above.

When no searched highlighted contents exit, in operation S150, the display unit 110 outputs a search failure message to the user.

According to the above description, the computing apparatus 100 collects, extracts, and stores the contents highlighted by the user. Then, the computing apparatus 100 effectively searches wanted highlighted contents according to the input search condition to provide it to the user. As a result, the user using the contents will have improved learning abilities and results.

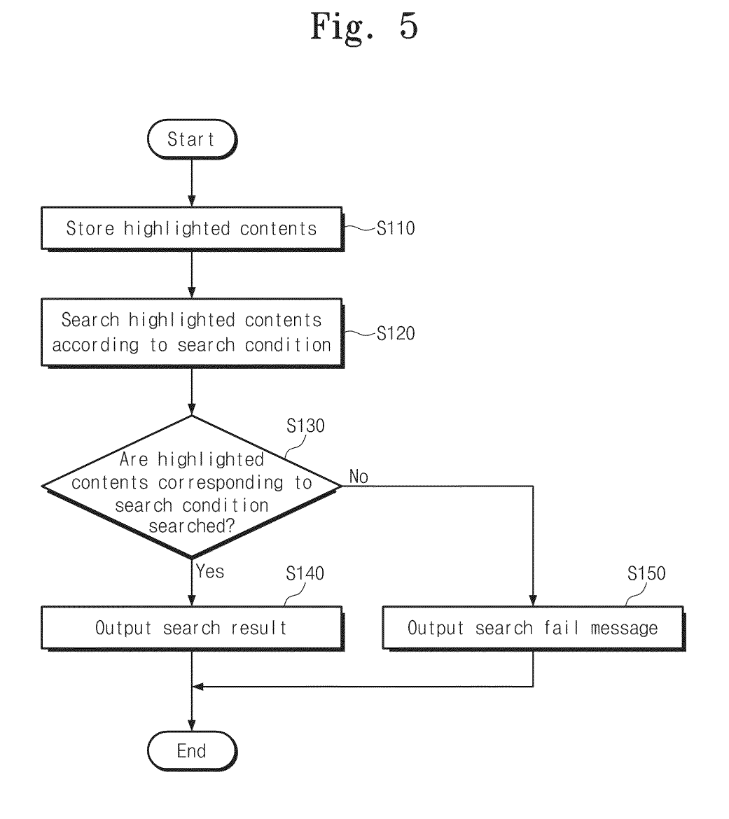

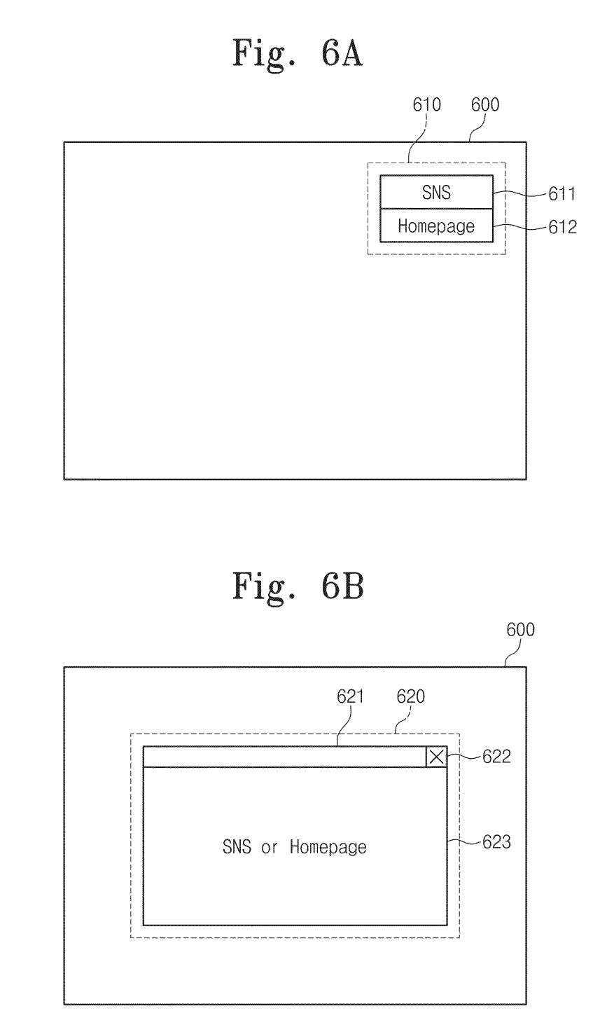

FIG. 6A is a diagram describing a community access method according to another embodiment of the inventive concept. A community access method of a computing device 100 (refer to FIG. 1) enabling the user to conveniently connect to an external community will be described with reference to FIG. 6A.

Referring to FIG. 6A, a screen 600 of a display unit 110 (refer to FIG. 1) includes a connection interface field 610 to provide a community access method. The connection interface field 610 may provide an interface that enables the user to quickly and easily connect to the external network. The connection interface field 610 may be always exposed in the screen 600 depending on the computing configuration.

In example embodiments, it is assumed that the user uses specific contents through the computing apparatus 100. Herein, the used specific contents are defined as target contents. Alternatively, the contents predetermined by the user are defined as the target contents.

The user may use the connection interface field 610 to access the community of the target contents. Herein, the community of the target contents may include an internet website provided by a target contents provider or a social network service (SNS) which users of the target contents use.

In example embodiments, a social network service page may include Google+, facebook, blog, twitter, me2 day, weibo, or the like.

In example embodiments, the connection interface field 610 may include an SNS (social network service) tab 611 and a website tab 612.

The SNS tab 611 is an interface used to access the social network service page for the target contents community. The website tab 612 is an interface used to access the internet websites for the target contents community. The internet website may include official websites provided by the target contents provider or private homepages operated by personal internet users.

The user instructs an access to the target contents community by selecting one of the SNS tab 611 and the website tab 612.

Once the access command is inputted by the user, the computing apparatus 100 reads a community address of the target contents. Herein, the community address may be provided by a target contents provider. Alternatively, the community address may be entered beforehand into the computing apparatus 100 by the user.

Meanwhile, when several community addresses for the target contents exist, whether any one of the community addresses is selected may be determined based on a predetermined condition. In example embodiments, the selection condition for the community address may be decided by the number of users of the community, quantity of contents provided by the community, quality of the contents provided by the community, and update frequency of the contents provided by the community. In example embodiments, in the case that the user previously selects the community address to be used, the selected community address will be selected preferentially.

The community address is read by a control unit 130 (refer to FIG. 1). The control unit 130 transmits an access command to a network unit 150 (refer to FIG. 1) based on the read community address.

The network unit 150 connects to the target contents community based on the access command. The network unit 150 connects to the target contents community through an external network 200 (refer to FIG. 1). The detailed configuration and operation of the network unit 150 may be substantially identical to that described above.

In example embodiments, computing apparatus 100 may automatically provide the user information to the target contents community to connect to the community. The user information may include login information to log in to the community. With the above description, the user may access the community without direct entering of the login information. Therefore, it is possible to increase the convenience of user.

When the computing apparatus 100 is connected to the target contents community, the control unit 130 receives the community contents from the community to provide it to the display unit 110. The computing apparatus 100 provides the community contents to the user through the display unit 110.

In example embodiments, the community contents provided to the user may include web documents, pictures, videos, sound data, and/or hyperlinks.

In example embodiments, the community contents provided to the user may include group chatting or webcam service. The user may discuss and communicate in real time through the group chatting or webcam service.

Particularly, via the webcam service, the user may provide contents to other users in real time or receive contents of other users in real time. Therefore, the user may experience improved learning capabilities.

FIG. 6B is a diagram schematically illustrating community contents according to another embodiment of the inventive concept. Referring to FIG. 6B, a screen 600 of a display unit 110 (refer to FIG. 1) includes community contents 620.

A computing apparatus 100 (refer to FIG. 1) provides the community contents 620 through a web browser or Windows.

In example embodiments, when provided by the web browser, the community contents 620 may include an address bar 621, an exit button 622, and a contents display area 623.

In example embodiments, the user may download data associated with target contents through the community contents 620. Also, the user may conduct exchange of opinions and inquiry responses with another user of the target contents through the community contents 620. Also, the user may provide own data to other users through the community contents 620.

In example embodiments, the computing apparatus 100 may process feedbacks associated with exchange of opinions and inquiry responses of the user.

In the case that the user composes a post in the connected community through the computing apparatus 100, opinions and replies of other users related to the composed post may be written. In this case, the computing apparatus 100 receives a signal (i.e. an alarm signal) indicating that a reply is written by mutual interacting with the community. The computing apparatus 100 displays the alarm signal to the user.

In example embodiments, the computing apparatus 100 may display the alarm signal to the user through a separate notification window or icon. Also, if the user selects the notification window or icon for displaying of the alarm signal, the computing apparatus 100 connects to the community providing the alarm signal. At this time, the computing apparatus 100 may indicate the other user's response or reply to the user by directly approaching the part in which the other user's response or reply is left.

A method of connecting to the social network service page or websites corresponding to the target contents through the connection interface field 610 is described with reference to FIGS. 6A and 6B. However, the inventive concept is not limited thereto. For example, the user can connect to a messenger that is related to the target contents through the connection interface field 610. Herein, the connection interface field 610 may include a messenger tab. In example embodiments, a messenger accessed through the messenger tab may include kakaotalk, mypeople, tictoc, and/or line.

The messenger tab may operate in the same manner as the SNS tab 11 or the website tab 612 described above.

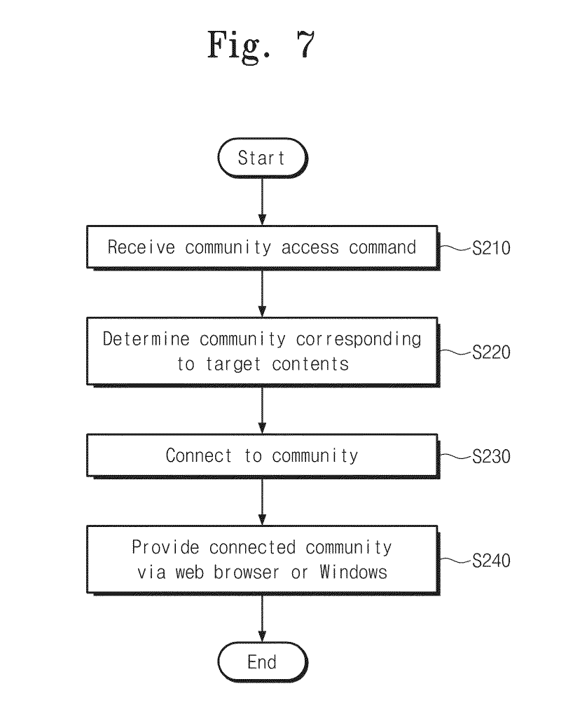

FIG. 7 is a flowchart describing a contents providing method according to another embodiment of the inventive concept. A method of providing the user with contents received from a community will be described. This may be made by a computing apparatus 100 (refer to FIG. 1). Referring to FIG. 7, the contents providing method may include operations S210 to S240.

In operation S210, the computing apparatus 100 receives a community access command from the user through a display unit 110 (refer to FIG. 1). Herein, the community access command may be a command used to access a target contents community. The target contents and the target content community may be substantially identical to that mentioned above.

In example embodiments, a control unit 110 (refer to FIG. 1) can receive the community access command through a connection interface field 610 (refer to FIG. 6A).

In operation S220, a control unit 110 reads a community address based on the community access command. The control unit 110 selects a community to be connected according to the read community address.

Reading of the community address and selecting of the community may be made in the same manner as described above.

In operation S230, the control unit 110 transmits the community access command to a network unit 150. The network unit 150 connects with the computing apparatus 100 in response to the community access command.

The network unit 150 connects the computing apparatus 100 to the community through an external network 200 (refer to FIG. 1). The external network 200 may include a wire or wireless communications network.

In operation S240, the computing apparatus 100 receives community contents from the connected community. Then, the computing apparatus 100 provides the received community contents to the user. In example embodiments, the computing apparatus 100 may provide the community contents to the user through a display unit 110 (refer to FIG. 1). Also, the computing apparatus 100 can provide the community contents to the user through a web browser or Windows.

The computing apparatus 100 may provide the user with the community contents in the same manner as described above, and the community contents may be substantially identical to that described above.

With the above description, the user readily connects to the external network 200 corresponding to the contents which are read through the computing apparatus 100. As a result, the user will experience improved learning abilities and results.

In example embodiments, a contents providing method according to an embodiment of the inventive concept may support a cloud service to back up stored data and/or contents in the computing apparatus 100. In more detail, the computing apparatus 100 may approach the cloud service provider through the network unit 150. Then, the computing apparatus 100 frequently transmits the data and/or contents stored in the computing apparatus 100 to the cloud server provided by the cloud service provider.

With the above description, data or contents stored in the computing apparatus 100 may be backed up frequently in the cloud server. Therefore, the user may restore the data or contents from the cloud server even if they are lost.

Also, the user may download data or contents stored in the cloud server through other devices (i.e. a personal computer, a smart phone, etc.). Therefore, the user may access data or contents stored in the computing apparatus 100 through other devices without the computing apparatus 100.

It is well known in the art that the computing apparatus 100 interfaces with a cloud server (not shown) through a cloud service, and description thereof is thus omitted.

FIG. 8 is a diagram describing a writing-inhibited area setting method of a computing device according to an embodiment of the inventive concept. In FIG. 8, a computing apparatus 100 (refer to FIG. 1) provides an interface to set an area in which writing is prohibited. Referring to FIG. 8 a screen 700 of a display unit 110 (refer to FIG. 1) includes a writing area 710, a writing-inhibited area 720, a configuration area 720, and a control area 730.

The writing area 710 is an area in which the user takes notes. In example embodiments, the computing apparatus 100 recognizes the written inputs through the touch-sensitive method. Herein, the display unit 110 may include a touch pad. The written input is made along the touch input given by the user in the writing area 710. Writing using a touch-sensitive method, a touch pad, and other writing methods may be well known in the art, and description thereof is thus omitted.

The writing-inhibited area 740 is an area in which the user is unable to make a written input. In more detail, the computing apparatus 740 may recognize the touch made at the writing-inhibited area 740 by the user to be invalid. The writing-inhibited area 740 may be used as a touch pick-up area when the user is making a written input. When writing is performed using the touch sensitive method, a touch picked up by user's hand movement can be recognized as a written input. This may causes errors in written inputs. Therefore, it is possible to remove the errors by setting the writing-inhibited area 740 and making the user take the writing-inhibited area 740.

In example embodiments, the writing-inhibited area 740 may be provided as a separate area. Also, the writing-inhibited area 740 may move along with the user's touch input. In more detail, if the user drags the input with the writing-inhibited area 740 being touched, the writing-inhibited area 740 may move along with the user's drag. As a result, even if the location of the user's hand moves, the writing-inhibited area 740 traces the hand movements and prevents unintentional hand pickups.

In example embodiments, the writing-inhibited area 740 may be enlarged or reduced in size by the user's touch. To distinguish from the hand movement or pickup trace function of the writing-inhibited area 740, the user may enlarge or downsize the writing-inhibited area 740 via dragging with multiple touches forced to the writing-inhibited area 740. For example, the user may enlarge or downsize the writing-inhibited area 740 by dragging two points simultaneously touched at the writing-inhibited area 740. Herein, the user can drag the two touch point inputs in the same direction or in different directions.

In example embodiments, the writing-inhibited area 740 may be enlarged or downsized in the dragged direction in the case that the user drags each point in the same direction. Also, in the case that the user drags each point in different directions, the writing-inhibited area 740 may be enlarged or downsized using two dragged directions as an enlarging or downsizing axis.

The configuration area 720 is used to set a shape of the writing-inhibited area 740. In FIG. 8, there is illustrated an example that the writing-inhibited area 740 has a diamond shape. However, the inventive concept is not limited thereto. For example, it is well understood that the writing-inhibited area 740 is set to have a circle shape, an ellipse shape, or a triangle shape.

In example embodiments, the configuration area 720 has three configuration tabs 721, 722, and 723. Each of the configuration tabs 721, 722, and 723 may represent a specific shape of the writing-inhibited area 740. For example, upon selecting of the configuration tab 721, the writing-inhibited area 740 may have a round shape. Upon selecting of the configuration tab 722, the writing-inhibited area 740 may have an elliptical shape. Likewise, upon selecting of the configuration tab 723, the writing-inhibited area 740 may have another specific shape.

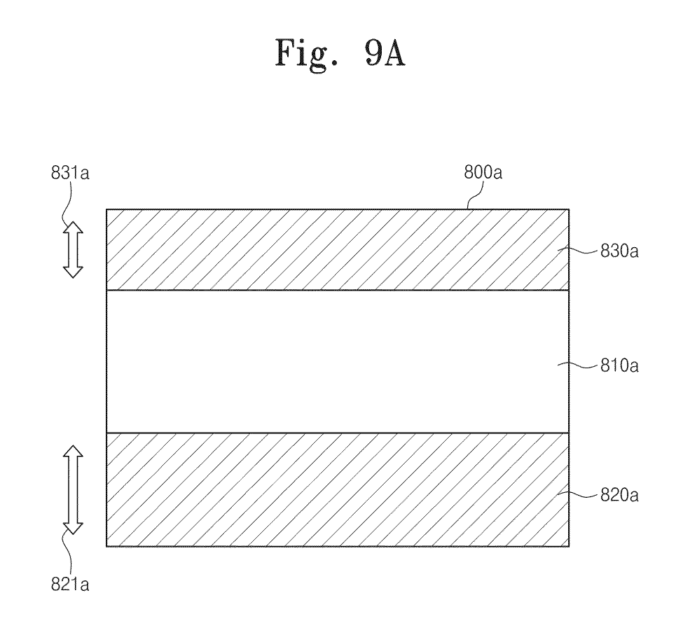

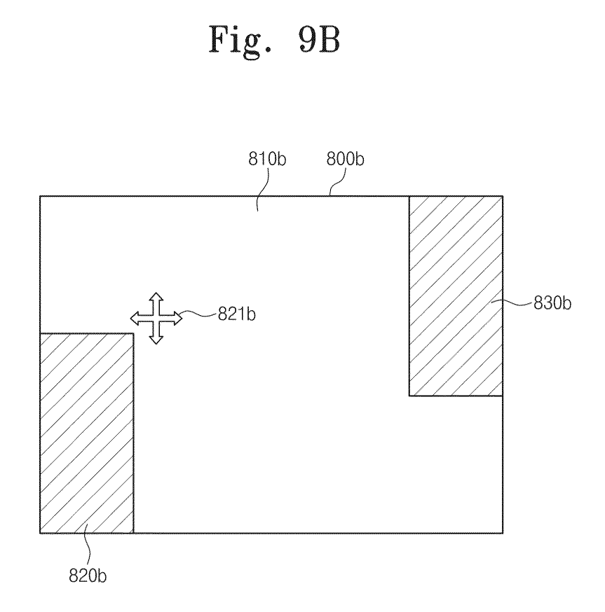

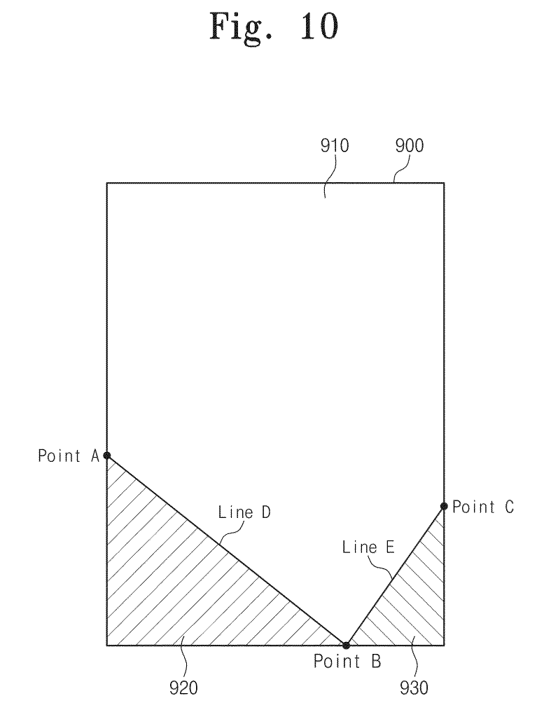

In example embodiments, the configuration tabs 721, 722, and 723 may be used as a menu for selecting each embodiment associated with a method of setting a writing-inhibited area. In other words, upon selecting of the configuration tab 721, an embodiment in FIG. 8 may be selected. Upon selecting of the configuration tab 722, an embodiment to be described in FIG. 9A or 9B may be selected. Upon selecting of the configuration tab 723, an embodiment to be described in FIG. 10 may be selected.

Example embodiments according to the inventive concept will be more fully described with reference to accompanying drawings, later.

The control area 730 is used to control creation or change of the writing-inhibited area 740. In example embodiments, the control area 730 contains three functional tabs func1, func2, and func3. The 1st functional tab func1 may be used to create the writing-inhibited area 740. The 2nd functional tab func2 may be used to fix a location of the writing-inhibited area 740. The 3rd functional tab func3 may be used to remove the writing-inhibited area 740.

In this case, if the user selects the 1st functional tab func1, the writing-inhibited area 740 is created. If the user selects the 2nd functional tab func2, the writing-inhibited area 740 is fixed. In the case that the 2nd functional tab func2 is selected, the writing-inhibited area 740 does not move even if the user makes a drag after touching the writing-inhibited area 740. In other words, even if the location of hand pick-up changes, the writing-inhibited area 740 does not trace the movement of the hands.

The writing-inhibited area 740 is removed if the user selects the 3rd functional tab func3.

An interface used to configure the writing-inhibited area 740 may be controlled by a control unit 130 (refer to FIG. 1).

According to the above description, there may be the writing-inhibited area 740 in which the user's touch is not recognized as a written input. The writing-inhibited area 740 actively moves by tracing the user's hand movement. Therefore, it is possible to prevent mistakes in written inputs due to user's unintended hand movements, regardless of their locations. As a result, the convenience of the user on writing may be improved.

FIG. 9A is a diagram describing a writing-inhibited area setting method of a computing device according to another embodiment of the inventive concept. Referring to FIG. 9A, a screen 800a of a display unit 110 (refer to FIG. 1) includes a writing area 810a and writing-inhibited areas 820a and 830a.

Direction movement symbols 821a and 831a are used to explain moving and extending directions of the writing-inhibited areas 820a and 830a. The direction movement symbols 821a and 831a are not actually displayed on the screen 800a.

The writing area 810a is an area in which the user makes written inputs by a touch. The writing-inhibited areas 820a and 830a are areas in which user's touches are recognized to be invalid inputs. The writing area 810a and the writing-inhibited areas 820a and 830a may be substantially identical to those described in FIG. 8. Note that the writing-inhibited areas 820a and 830a are enlarged, downsized, or moved in vertical directions. In FIG. 8, a writing-inhibited area 740 moves to any location on a screen 700 by tracing unintended hand movement. Conversely, the writing-inhibited areas 820a and 830a may be moved, enlarged, or downsized in directions (e.g., up and down direction) directed by the symbols 821a and 831a.

Like FIG. 8, the writing-inhibited areas 820a and 830a are moved, enlarged, or downsized by dragging the writing-inhibited areas 820a and 830a towards directions indicated by the symbols 821a and 831a with the writing-inhibited areas 820a and 830a touched by the user.

According to the above description, another embodiment may be provided in which the writing-inhibited areas 820a and 830a recognize the user's touch input to be invalid.

FIG. 9B is a diagram describing a writing-inhibited area setting method of a computing device according to still another embodiment of the inventive concept. Referring to FIG. 9B, a screen 800b of a display unit 110 (refer to FIG. 1) includes a writing area 810b and writing-inhibited areas 820b and 830b.

Direction movement symbol 821b is used to explain moving and extending directions of the writing-inhibited area 820b. The direction movement symbol 821b is a component which is not displayed on the screen 800b.

The writing area 810b is an area in which the user makes written inputs by a touch. The writing-inhibited areas 820b and 830b are areas in which user's touches are recognized to be invalid inputs. The touch recognition of the writing area 810b and the writing-inhibited areas 820b and 830b may be performed in the same manner as described in FIG. 8. However, the inventive concept is not limited thereto.

In example embodiments, the writing-inhibited areas 820b and 830b may be enlarged, downsized, or moved in vertical or horizontal directions of the screen 800b. In FIG. 8, a writing-inhibited area 740 moves to any location on a screen 700 by tracing unintended hand movement. Conversely, the writing-inhibited area 820b may be moved, enlarged, or downsized in directions (e.g., vertical or horizontal direction) directed by the symbol 821b.

In FIG. 9B, there is illustrated the direction movement symbol 821b associated with the writing-inhibited area 820b. However, the writing-inhibited area 830b can be enlarged or downsized in the same method (vertical or horizontal).

Like FIG. 8, the writing-inhibited areas 820b and 830b are moved, enlarged, or downsized by dragging the writing-inhibited areas 820b and 830b towards a direction indicated by a symbol with the writing-inhibited areas 820b and 830b touched by the user.

According to the above description, still another embodiment may be provided in which the writing-inhibited areas 820b and 830b recognize the user's touch input to be invalid.

FIG. 10 is a diagram describing a writing-inhibited area setting method of a computing device according to still another embodiment of the inventive concept. Referring to FIG. 10, a screen 900 of a display unit 110 (refer to FIG. 1) includes a writing area 910 and writing-inhibited areas 920 and 930.

The writing area 910 is an area in which the user makes written input with a touch. The writing-inhibited areas 920 and 930 are areas in which user's touches are recognized to be invalid inputs. The touch recognition of the writing area 910 and the writing-inhibited areas 920 and 930 may be made in the same manner as described in FIG. 8.

In example embodiments, the user selects multiple points on the edge of the screen 900 to configure the writing-inhibited areas 920 and 930. The points selected by the user may include multiple points the number of which is greater than 2. Herein, there will be described an example that the user selects three points.

The user selects one point from each of the three edges out of the four sides on the screen 900. It is assumed that the user selected a point from each of the three edges of the screen 900 except the top edge.

The user arbitrarily selects points (e.g., point a, point b, and point c) from the left edge, the bottom edge, and the right edge, respectively. Then, a computing apparatus 100 (refer to FIG. 1) configures a straight line connecting two points that are located closest to each other. In other words, the computing apparatus 100 may configure a straight line D connecting the points A and B and a line E connecting points B and C.

However, as this is only an example, the computing apparatus 100 may configure a straight line through other methods (i.e., connecting two points from two edges facing each other).

Also, the computing apparatus 100 may configure the areas 920 and 930 surrounded by borders created from configured lines D and E and the screen 900 as the writing-inhibited areas.

The configured writing-inhibited areas 920 and 930 may be moved, enlarged, or downsized by the user's touch inputs. The move, enlarge, and downsize actions of the writing-inhibited areas 920 and 930 by touch inputs may be made in the same manner as described in FIG. 8.

According to the above description, still another embodiment may be provided in which the writing-inhibited areas 920 and 930 recognize the user's touch input to be invalid.

The writing-inhibited area setting methods according to various embodiments of the inventive concept are described with reference to FIGS. 8 to 10. In each embodiment, the computing apparatus 100 recognizes the user touch input through the display unit 100. Then, the computing apparatus 100 controls the writing-inhibited areas through a control unit 130.

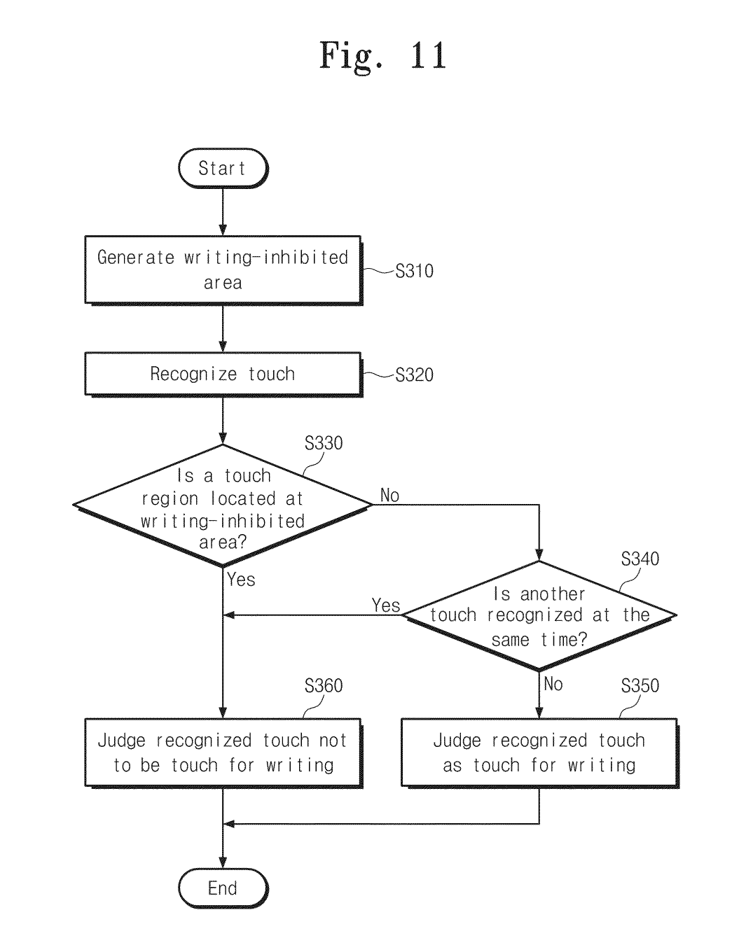

FIG. 11 is a flowchart describing a touch recognizing method of a computing apparatus according to an embodiment of the inventive concept. Referring to FIG. 11, a touch recognizing method of a computing apparatus according to an embodiment of the inventive concept may include operations S310 to S360.

In operation S310, the computing apparatus 100 generates a writing-prohibited area. This may be performed in the same manner as described with reference to FIGS. 8 to 10.

In operation S320, the computing apparatus 100 recognizes user's touch inputs through a display unit 110 (refer to FIG. 1). The display unit 110 may operate substantially the same as described above.

In operation S330, the computing apparatus 100 judges whether the touch input is detected in a writing-prohibited area. The touch recognizing method proceeds to operation S360 if the user input is detected in the writing-prohibited area. The method proceeds to operation S340 if the user input is detected elsewhere (i.e., writing area).

In operation S340, the computing apparatus 100 judges if another user input is detected at the same time in an area other than the writing-prohibited area. In a case where another touch input is detected in an area other than the writing-prohibited area, an error may occur in the writing process. Therefore, in this case, the touch may be recognized as an invalid touch unneeded for writing.

If another touch is detected, the method proceeds to operation S360. If not, the method proceeds to operation S350.

In operation S350, the computing apparatus 100 judges the recognized touch input as touch used for writing, and performs the action.

In operation S360, the computing apparatus 100 judges the recognized touch input as touch unnecessary for writing, and does not apply the touch to the writing process.

With the inventive concept, the computing apparatus 100 provides a writing method to the user through the touch recognizing method. The computing apparatus 100 improves the user's ease of access through the improved method of configuring the writing-prohibited area. As a result, the user is provided with an effective and convenient writing method.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A contents providing method of a computing apparatus, comprising:
storing highlighted contents in a storage unit;
searching the highlighted contents based on a search condition;
reading the highlighted contents from the storage unit according to a search result; and
providing the read highlighted contents to a user via a display unit.

2. The contents providing method of claim 1, further comprising:
providing a writing area to receive a written input of the user via the display unit.

3. The contents providing method of claim 1, wherein the highlighted contents include one of a highlighted field, a page area containing the highlighted field, an address of the highlighted field, or an address or hyperlink of the page area.

4. The contents providing method of claim 2, wherein the highlighted field is highlighted through an underline or painting.

5. The contents providing method of claim 1, wherein the searching the highlighted contents comprises providing the search result to the user via the display unit.

6. A contents providing method of a computing apparatus, comprising:
receiving a community access command from a user;
determining a community corresponding to target contents based on the community access command;
connecting to the community through a wired or wireless network via a network unit;
receiving community contents from the community through the network unit; and
providing the community contents to the user via a display unit.

7. The contents providing method of claim 6, wherein the target contents include contents being read by the user through the computing apparatus or contents configured by the user beforehand.

8. The contents providing method of claim 7, wherein the contents being read or the contents preconfigured include e-book contents.

9. The contents providing method of claim 6, wherein the community contents include at least one of a web document, a picture, a video, sound data, or a hyperlink.

10. The contents providing method of claim 6, wherein the community includes an internet website, a social network service (SNS), or a messenger

11. The contents providing method of claim 10, wherein the social network service includes Google+, facebook, blog, twitter, me2 day, or weibo.

12. The contents providing method of claim 10, wherein the messenger includes kakaotalk, mypeople, tictoc, or line.

13. The contents providing method of claim 6, further comprising:
receiving user contents from the user; and
providing the user contents to the community via the network unit.

14. The contents providing method of claim 13, wherein the user contents include a web document, a picture, a video, sound data, or a hyperlink provided to the community by the user.

15. The contents providing method of claim 6, further comprising:
providing user information to the community.

16. The contents providing method of claim 15, wherein the user information includes login information required to log-in to the community.

17. A computing apparatus comprising:
a storage unit configured to store highlighted contents;
a control unit configured to search the highlighted contents based on a search condition and to read the highlighted contents from the storage unit based on the search result, and
a display unit configured to provide the read highlighted contents to a user.

18. The computing apparatus of claim 17, wherein the highlighted contents include one of a highlighted field, a page area containing the highlighted field, an address of the highlighted field, or an address or hyperlink of the page area.

19. The computing apparatus of claim 17, wherein the display unit provides the search result to the user.
